(19) United States
(12) Patent Application Publication
(10) Pub. No.: US 2018/0321608 A1
(43) Pub. Date: Nov. 8, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Shinsaku Ito, Yokohama (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/690,652

(22) Filed: Aug. 30, 2017

(30) Foreign Application Priority Data
May 8, 2017 (JP) 2017-092322

(51) Int. Cl. G03G 15/00; H04N 1/409; H04N 1/407; H04N 1/00

(52) U.S. Cl. CPC G03G 15/0121; H04N 1/00811; H04N 1/407; H04N 1/4092

(57) ABSTRACT

A first image forming section forms a monochromatic image with a first color material. A second image forming section forms a monochromatic image with a second color material different from the first color material. A color material selection section selects either the first color material or the second color material as a color material for image formation by a user. An acquisition section reads a document to acquire image data indicating the document. A mode selection section selects, by a user, either a first mode in which a first image processing is executed as an image processing on the image data acquired by the acquisition section or a second mode in which a second image processing, different from the first image processing, for increasing visibility of a color formed on a sheet regardless of a color material selected by the color material selection section, is executed.

### CROSS-REFERENCE TO RELATED APPLICATION

This application is based upon and claims the benefit of priority from Japanese Patent Application No. 2017-092322, filed May 8, 2017, the entire contents of which are incorporated herein by reference.

### FIELD

The present disclosure relates generally to an image forming apparatus.

### BACKGROUND

There is an image forming apparatus capable of forming an image using a plurality of color materials including a color material of a specific color which is decolorable by heating. A sheet on which the image is formed with a decolorable color material is copied in some cases.

The sheet on which the image is formed with the decolorable color material has lower developing density than a non-decoloring color material such as a black toner.

### DESCRIPTION OF THE DRAWINGS

FIG. 1 is a side view illustrating an image forming apparatus according to an embodiment;

FIG. 2 is a diagram illustrating the arrangement of a photoconductive drum and peripheral sections thereof, according to an embodiment;

FIG. 3 is a diagram illustrating a control circuit of an image forming apparatus according to an embodiment;

FIG. 4 is a diagram illustrating various processing executed by an image processing section according to an embodiment;

FIG. 5 is a diagram illustrating a screen displayed on a liquid crystal display section according to an embodiment;

FIG. 6 is a flowchart illustrating the flow of a processing by an image forming apparatus according to an embodiment;

FIG. 7 is a flowchart illustrating the flow of a processing by an image forming apparatus according to an embodiment; and

FIG. 8 is a flowchart illustrating the flow of a processing by an image forming apparatus according to an embodiment.

### DETAILED DESCRIPTION

As mentioned above, a sheet on which an image is formed with decolorable color material has lower developing density than a non-decoloring color material such as a black toner. Therefore, if the sheet on which the image is formed with the decolorable color material is copied by executing the same image processing as the sheet on which the image is formed with the non-decolorable color material, an image with thin color and low visibility is formed. Accordingly, there is a problem that it is hard to achieve good usability for a user who uses the image forming apparatus capable of forming an image with either the non-decoloring color material or the decoloring color material.

In accordance with an embodiment, an image forming apparatus comprises a first image forming section, a second image forming section, a color material selection section, an acquisition section and a mode selection section. The first image forming section forms a monochromatic image with a first color material. The second image forming section forms a monochromatic image with a second color material different from the first color material. The color material selection section selects either one of the first color material and the second color material as a color material used in image formation by a user. The acquisition section reads a document to acquire image data indicating the document. The mode selection section selects by a user either one of a first mode in which a first image processing is executed as an image processing on the image data acquired by the acquisition section and a second mode in which a second image processing, different with the first image processing, for increasing visibility of a color formed on a sheet regardless of a color material selected by the color material selection section is executed.

In an image forming apparatus of an embodiment, an image forming apparatus that improves usability for a user can be provided. Hereinafter, the image forming apparatus of an embodiment is described.

The image forming apparatus 1 according to an embodiment can form an image with a first color material and a second color material. In the present embodiment, as an example of the first color material, the black toner is used. As an example of the second color material, the decoloring toner is used. The black toner is a non-decoloring recording agent. The decoloring toner is a decoloring recording agent. The decoloring toner has lower color developing density than the black toner. The decoloring toner develops color at a temperature lower than a predetermined value to become visible, and is decolorized at a temperature equal to or greater than the predetermined value to become invisible. The decoloring toner may be blue, for example, and is formed on the sheet.

An image forming apparatus according to an embodiment has a copy function. In the copy function, a non-decoloring sheet on which an image is formed with the non-decoloring recording agent such as the black toner and a colored sheet (e.g., a blue sheet) on which an image is formed with the decoloring toner can be read as documents. The non-decoloring sheet is not limited to a sheet on which an image is formed with single color, but also includes an image formed with multiple colors.

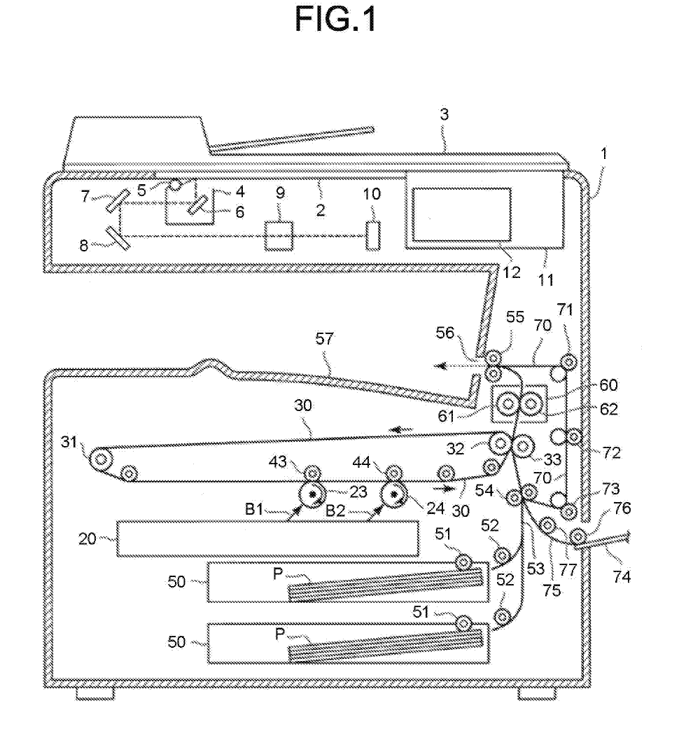

FIG. 1 is a side view illustrating an image forming apparatus 1 according to an embodiment. A transparent document table (glass plate) 2 for placing the document is arranged at the top of the image forming apparatus 1. A cover 3 is arranged on the document table 2 in an openable manner. A carriage 4 is arranged at lower side of the document table 2. An exposure lamp 5 is arranged in the carriage 4.

The carriage 4 reciprocates along the lower surface of the document table 2. The exposure lamp 5 exposes the document on the document table 2 along with the reciprocation of the carriage 4. A reflected light image generated by the exposure is received by a CCD (Charge Coupled Device) 10 via reflection mirrors 6, 7 and 8 and a zoom lens block 9. The CCD 10 outputs an image signal of a level corresponding to the reflected light image from the document by R (red), G (green) and B (blue).

A control panel 11 for setting an operation condition is arranged nearby the document table 2. The control panel 11 has a touch panel type liquid crystal display section 12.

An exposure unit 20 receives an image signal output by the CCD 10. The exposure unit 20 emits a laser beam B1 in response to the image signal of the decoloring toner towards a photoconductive drum 23 which is a carrier for the decoloring toner. The exposure unit 20 emits a laser beam B2 in response to the image signal of the black toner towards a photoconductive drum 24 which is a carrier for the black toner.

A transfer belt 30 is arranged above the photoconductive drums 23 and 24. The transfer belt 30 is wrapped around a driving roller 31 and a driven roller 32. The transfer belt 30 receives power from the driving roller 31 to rotate in a counterclockwise direction.

A primary transfer roller 43 facing the photoconductive drum 23 is arranged in a vertically movable manner.

A primary transfer roller 44 is arranged in a vertically movable manner at a position facing the photoconductive drum 24. The primary transfer roller 43 transfers an image on the photoconductive drum 23 onto a transfer belt 30 by rotating while pressing the transfer belt 30 towards the peripheral surface of the photoconductive drum 23. The primary transfer roller 44 transfers an image on the photoconductive drum 24 onto a transfer belt 30 by rotating while pressing the transfer belt 30 towards the peripheral surface of the photoconductive drum 24.

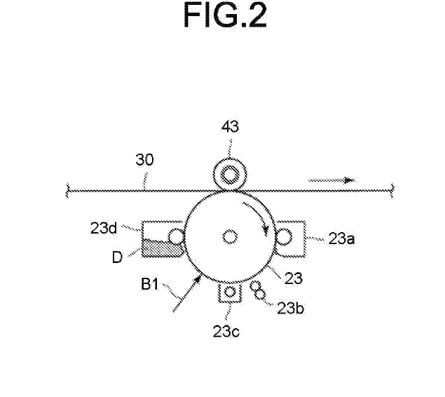

The configurations of the photoconductive drum 23 and the peripheral sections are shown in FIG. 2. A cleaner 23a, a discharging lamp 23b, a charging unit 23c and a developing unit 23d are arranged around the photoconductive drum 23. The cleaner 23a removes a developing agent left on the surface of the photoconductive drum 23. The discharging lamp 23b removes an electric charge left on the surface of the photoconductive drum 23. The charging unit 23c charges the surface of the photoconductive drum 23 with the electrostatic charge.

The surface of the photoconductive drum 23 charged by the charging unit 23c receives the laser beam B1 emitted by the exposure unit 20. The laser beam B1 forms an electrostatic latent image on the surface of the photoconductive drum 23. The developing unit 23d supplies a decoloring developer D to the surface of the photoconductive drum 23 to develop the electrostatic latent image on the surface of the photoconductive drum 23.

The peripheral sections of the photoconductive drum 24 may have the same configuration. Thus, the description thereof is omitted. A black developer D is supplied to the photoconductive drum 24. The photoconductive drum 23 and the peripheral sections thereof are collectively referred to as a first image forming section. The first image forming section forms a monochromatic image with non-decolorable toner such as black toner. The photoconductive drum 24 and the peripheral sections thereof are collectively referred to as a second image forming section. The second image forming section forms a monochromatic image with the decoloring toner.

A plurality of sheet feed cassettes 50 are arranged below the exposure unit 20. These sheet feed cassettes 50 house a plurality of sheets P which are image recording media which may have mutually different sizes.

A pickup roller 51 and a sheet feed roller 52 are arranged at positions facing the sheet feed cassette 50. Each pickup roller 51 picks up the sheets P one by one in the sheet feed cassette 50. Each sheet feed roller 52 supplies the sheet P picked by the pickup roller 51 to the conveyance path 53. The conveyance path 53 extends to a discharge port 56 at an upper side via a resist roller 54, the driven roller 32, a fixing unit 60, and a sheet discharge roller 55. The discharge port 56 is close to a sheet discharge tray 57.

A secondary transfer roller 33 is arranged to face the driven roller 32 across the transfer belt 30 and the conveyance path 53. The secondary transfer roller 33 transfers the image transferred onto the transfer belt 30 onto the sheet P sent from the resist roller 54.

A conveyance path 70 is arranged from the end of the conveyance path 53 to an upstream side end of the resist roller 54. The conveyance path 70 reverses a front surface and a back surface of the sheet P to return the sheet to the conveyance path 53. The conveyance path 70 has sheet feed rollers 71, 72 and 73.

A manual tray 74 is arranged on a side surface of the image forming apparatus 1 in a detachable manner. A conveyance path 75 is formed from the manual tray 74 to the upstream side of the resist roller 54 in the conveyance path 53. A pickup roller 76 and a sheet feed roller 77 are arranged at positions corresponding to the conveyance path 75. The pickup roller 76 picks up the sheets one by one from the manual tray 74. The sheet feed roller 77 supplies the sheet picked from the pickup roller 76 to the resist roller 54.

The fixing unit 60 includes a heat roller 61 and a pressure roller 62. The sheet P conveyed by the fixing unit 60 is heated at a temperature (for example, 100° C.) less than a predetermined value (for example, 120° C.) by the heat roller 61 to fix the image transferred onto the sheet P to the sheet P in a visible state. The fixing unit 60 heats the conveyed sheet P which is an invisible object at a temperature (for example, 130° C.) equal to or greater than the predetermined value by the heat roller 61 to make the image on the sheet P invisible.

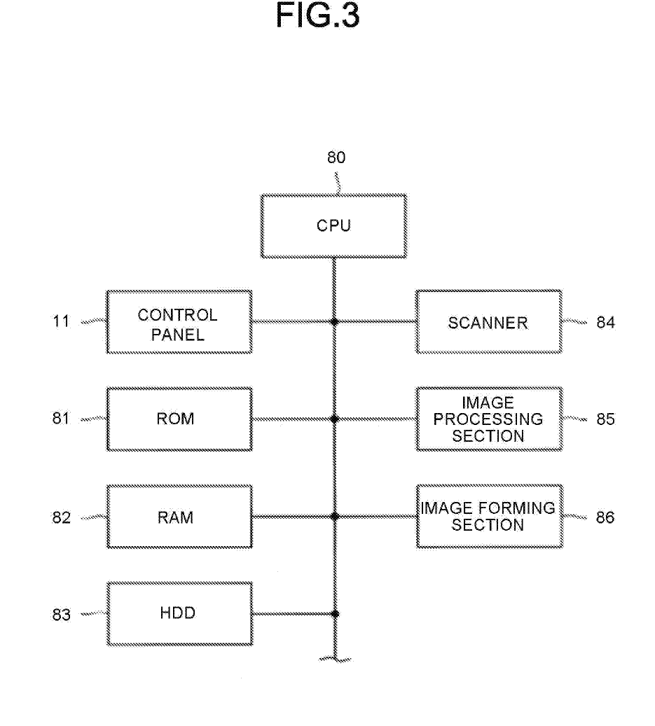

A control circuit of the image forming apparatus 1 is shown in FIG. 3.

A CPU 80 of a computer is connected to a control panel 11, a ROM 81, a RAM 82, a hard disc drive (HDD)83, a scanner 84, an image processing section 85, and an image forming section 86.

The control panel 11 is includes a numeric keypad, a start key and the like in addition to a touch panel type liquid crystal display section.

The ROM 81 stores various control programs. The RAM 82 stores various data. The hard disc drive 83 stores the image data. The scanner 84 includes a carriage 4, an exposure lamp 5, the reflection mirrors 6, 7 and 8, a zoom lens block 9 and the CCD 10. The scanner 84 optically scans the document on the document table 2 to read it to acquire the image data indicating the document. The image processing section 85 executes various processing on the image data acquired by the scanner 84.

In at least one embodiment, the image forming section 86 includes the exposure unit 20, the photoconductive drums 23 and 24, and an arrangement of components as shown in FIG. 2 with respect to the photoconductive drums. Further, in at least one embodiment, the image forming section 86 includes the transfer belt 30, the driving roller 31, the driven roller 32, the primary transfer rollers 43 and 44, the secondary transfer roller 33, the conveyance path 53, the fixing unit 60 and the conveyance path 70. The image forming section 86 forms an image based on the image data processed by the image processing section 85 on the sheet P.

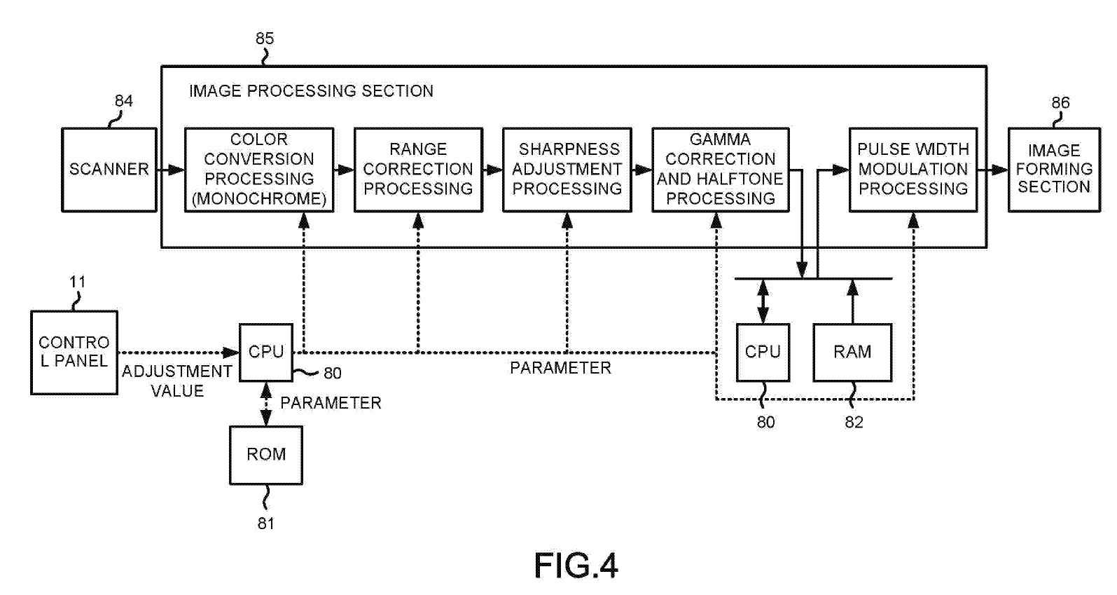

FIG. 4 is a diagram illustrating various processing executed by the image processing section 85. As the image processing executed by the image processing section 85 on the image data, there is a character and photograph document mode (first mode) for executing the first image processing, and a decoloring document mode (second mode) for executing a second image processing of increasing the visibility of a color formed on the sheet regardless of the color of the color material used in the image formation, which is different from the first image processing. In this way, the image processing section 85 executes both the first image processing and the second image processing.

In the first image processing, according to the image data acquired by the scanner 84, a character area and a photograph area are determined, and a processing of using at least one edge of the character area and a processing of generating gradations, such as increasing the number of gradations for the photograph area, are executed.

The second image processing is suitable for copying of the document of the decoloring sheet (e.g., a blue sheet). As described above, the decoloring toner has lower color developing density than the non-decoloring recording agent such as the black toner. Thus, the image data acquired by the scanner 84 from the blue sheet becomes the image data indicating a thin image as compared with the image data acquired by the scanner 84 from the non-decoloring sheet. Thus, in a case of executing the same processing as the image processing on the image data acquired by the scanner 84 from the non-decoloring sheet, a thin image is formed.

Therefore, in the second image processing, in order to increase the visibility of the color formed on the sheet, a processing of emphasizing the color of the color material is executed. Specifically, in the document of the blue sheet, the image is formed in blue (that is, in the decoloring color), and then, in the second image processing, a processing of emphasizing the image signal corresponding to B among the image signals of RCG output from the CCD 10 is performed. In this way, an image having the same density as the image data acquired by the scanner 84 from the non-decoloring sheet is formed. On basis of this, the image processing section 85 is described below.

The image processing section 85 executes a color conversion processing, a range correction processing, a sharpness adjustment processing, a gamma correction and halftone processing and a pulse width modulation processing. Each processing is executed according to parameters set by the CPU 80. The CPU 80 refers to an adjustment value indicating a setting content set by the control panel 11 to read appropriate parameters from the ROM 81. In the above-mentioned first image processing and second image processing, the parameters relating to the image processing are different. The parameter relating to the second image processing is used for executing the image processing of emphasizing the color of the toner. In the following description, the parameter set in the first image processing is referred to as a parameter for non-decoloring toner (e.g., the black toner) in some cases. The parameter set in the second image processing is referred to as a parameter for decoloring in some cases.

The image processing section 85 acquires the image signals of RGB (color image data) read by the scanner 84 to execute the color conversion processing. In the color conversion processing, the image signals of RGB are converted to a monochrome signal (K) (monochrome image data) of an appropriate density gradation. Next, the image processing section 85 executes the range correction processing to the monochrome image data subjected to the color conversion processing. In the range correction processing, for the purpose of easily seeing a line drawing part, an edge emphasis processing for emphasizing a change point of the image and a density difference between a ground and a character part are performed.

The image processing section 85 executes the sharpness adjustment processing on the image data subjected to the range correction processing. The sharpness adjustment processing adjusts a contour line of the image. The image processing section 85 executes the gamma correction and halftone processing on the image data subjected to the sharpness adjustment processing.

In the gamma correction and halftone processing, a gamma correction is executed in consideration of characteristics of an output device of the image forming section 86. A gamma correction and halftone processing section 83 executes a processing of expressing neutral color by executing dithering. In a pulse width modulation (PWM), in order to form a required gradation (a plurality of gradations) in response to the image data on the photoconductive drum, a pulse width and a pulse position are adjusted.

In at least one embodiment, the functions of the above-mentioned image processing section 85 may be realized by an ASIC (Application Specific Integrated Circuit). Among the processing executed by the image processing section 85, the color conversion processing, the range correction processing, the sharpness adjustment processing, and the pulse width modulation processing are common to the first image processing and the second image processing.

The image processing section can be employed for both the first and second image processing by executing a monochrome processing on either one of the color materials. In at least one embodiment, the ASIC uses the image processing section as a common image processing section for both first and second image processing. Thus, by having a common configuration which does not depend on the color material, it is possible to reduce the number of components, and to suppress cost and development steps of the hardware of the image forming apparatus. As the number of production lots increases, it is possible to obtain the benefits of scale accordingly.

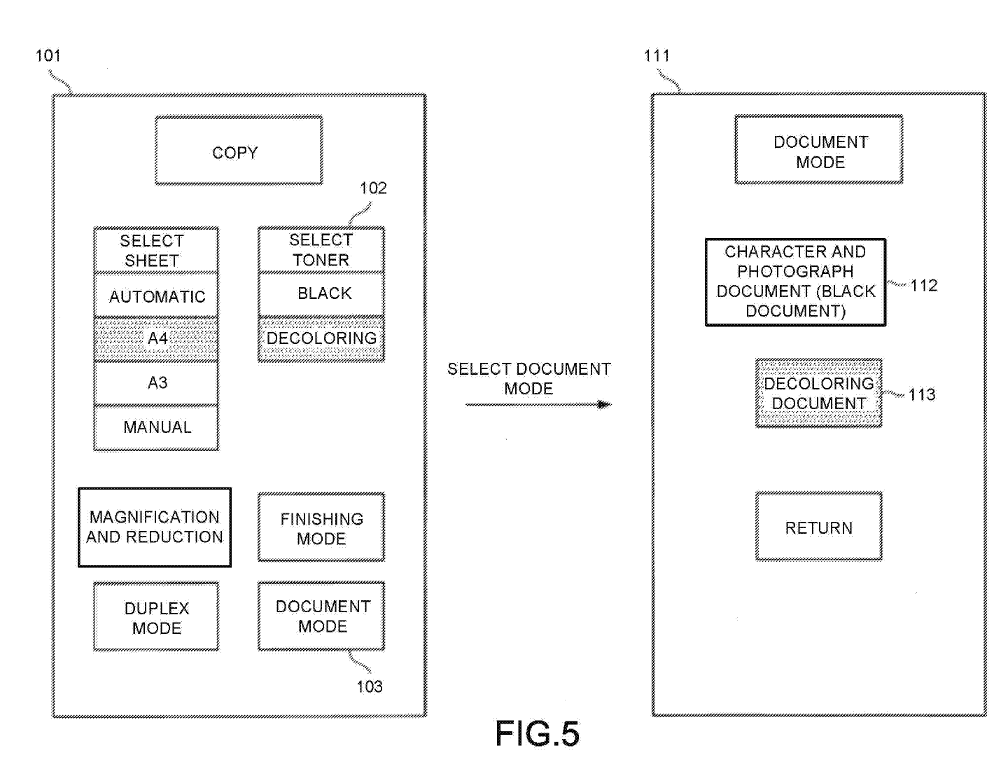

FIG. 5 is a diagram illustrating a screen displayed on the liquid crystal display section 12 according to an embodiment. On the liquid crystal display section 12, a copy screen 101 is displayed. In the copy screen 101, a color material selection section 102 for selecting either one of the black toner and the decoloring toner as the color material used in the image formation by a user is arranged. In the copy screen 101 of this embodiment, a state in which the decoloring toner is selected is shown.

On the copy screen 101, a document mode button 103 for switching to a screen for selecting the document mode is further arranged. If the user operates the document mode button 103, a document mode selection screen 111 is displayed. On the document mode selection screen 111, a character and photograph document (e.g., a black document) button 112, a decoloring document button 113 and a return button are displayed.

In the document mode selection screen 111, by the character and photograph document button 112 and the decoloring document button 113, as the document mode, the use selects either one of the character and photograph document mode and the decoloring document mode. In the character and photograph document mode, the first image processing is executed as described above. In the decoloring document mode, the second image processing is executed. The return button is used to return to the copy screen.

If the decoloring toner is selected as the color material used for image formation by the color material selection section 102 on the document mode selection screen 111, as shown in FIG. 5, the decoloring document mode is displayed by default on the document mode selection screen 111.

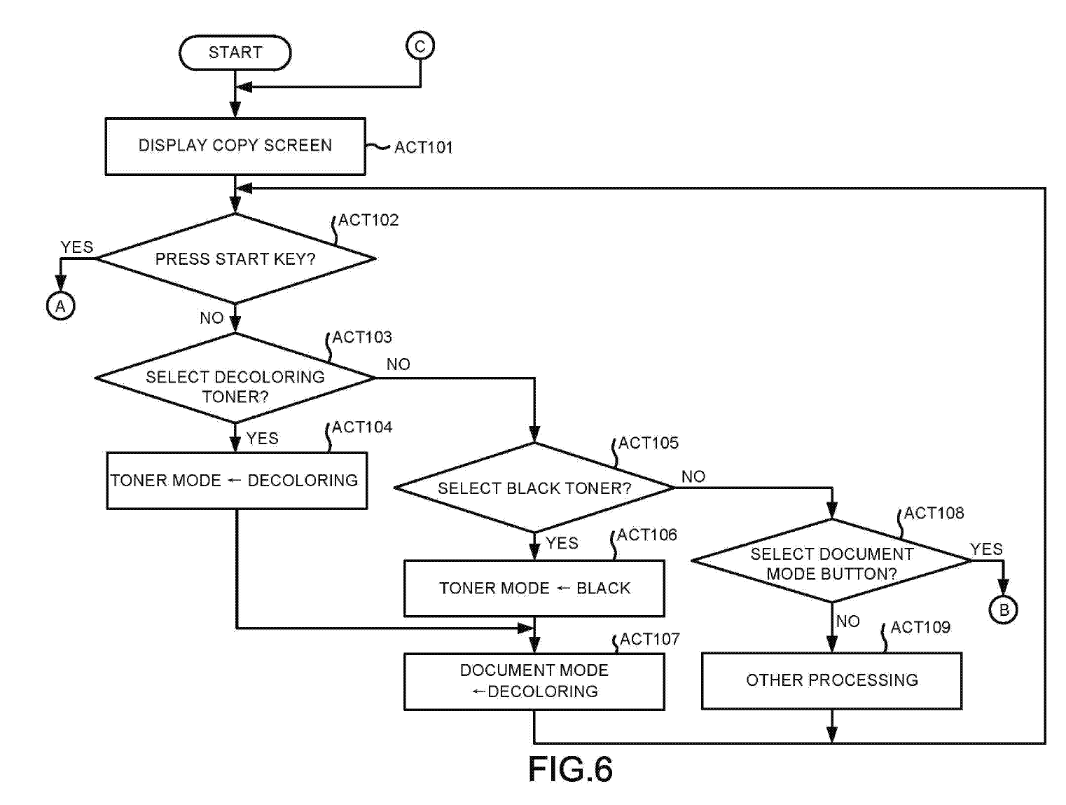

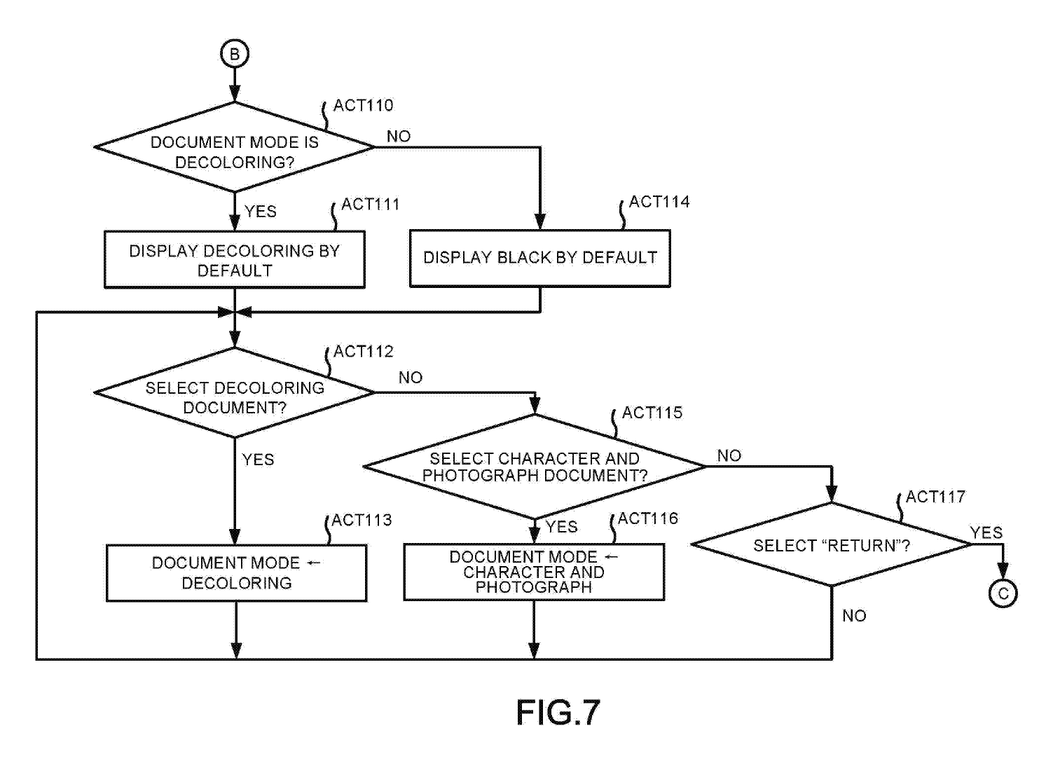

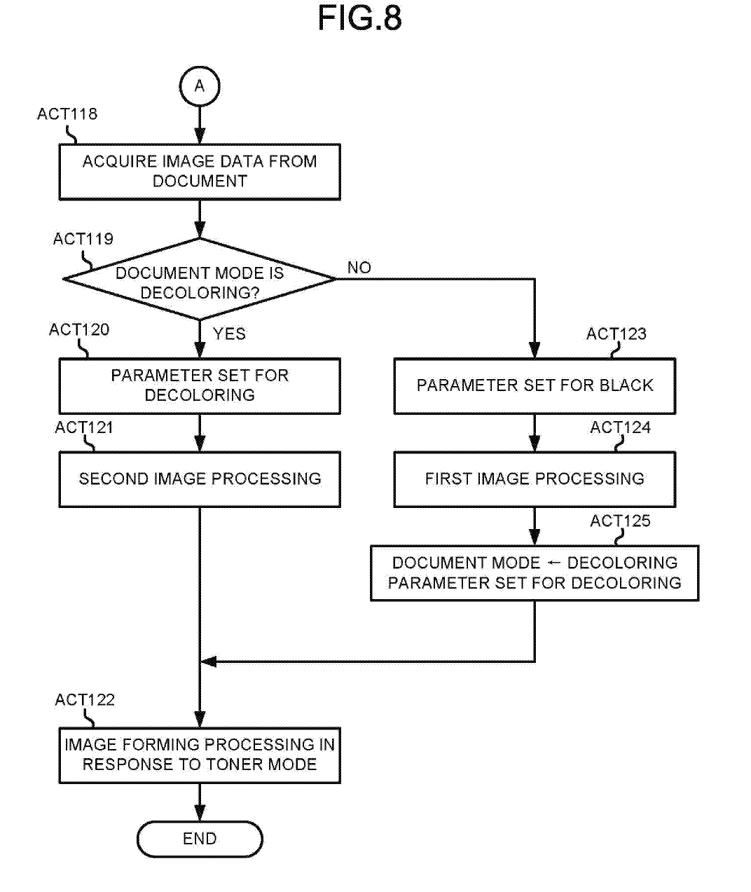

FIG. 6, FIG. 7, and FIG. 8 are flowcharts illustrating the flow of a processing by the image forming apparatus 1. Specifically, FIG. 6, FIG. 7, and FIG. 8 show a flow of the processing from the display of the copy screen 101 described above until the image is formed. The CPU 80 displays the copy screen 101 in the liquid crystal display section 12 (ACT 101). The CPU 80 determines whether or not the start key for starting copy arranged in the control panel 11 is pressed (ACT 102). If the start key is not pressed (No in ACT 102), the CPU 80 determines whether or not the decoloring toner is selected by the color material selection section 102 (ACT 103).

If the decoloring toner is selected by the color material selection section 102 (Yes in ACT 103), the CPU 80 sets “decoloring” as a toner mode (ACT 104). The toner mode indicates a toner used in the image formation. The CPU 80 sets the decoloring document mode as the document mode (ACT 107), and returns to the processing in ACT 102.

If the decoloring toner is not selected by the color material selection section 102 in ACT 103 (No in ACT 103), the CPU 80 determines whether or not the black toner is selected by the color material selection section 102 (ACT 105). If the black toner is selected by the color material selection section 102 (Yes in ACT 105), the CPU 80 sets “black” as the toner mode (ACT 104). The CPU 80 sets the decoloring document mode as the document mode (ACT 107), and returns to the processing in ACT 102.

In this way, even if the toner used in the image formation is either one of the toner described above, the decoloring document mode is set as the document mode. The default of the document mode becomes the decoloring document mode.

In ACT 105, if the black toner is not selected by the color material selection section 102 (No in ACT 105), the CPU 80 determined whether or not the document mode button 103 is selected (ACT 108). If the document mode button 103 is not selected (No in ACT 108), the CPU 80 executes other processing (ACT 109), and returns to the processing in ACT 102. The “other processing” corresponds to other buttons (the sheet selection, magnification or reduction) displayed on the copy screen 101.

In ACT 105, if the document mode button 103 is selected (Yes in ACT 108), as shown in FIG. 7, the CPU 80 determines whether or not the document mode is the decoloring document mode (ACT 110). If the document mode is the decoloring document mode (Yes in ACT 110), the CPU 80 displays the document mode screen 111 in which the decoloring document button 113 is set by default (ACT 111). On the other hand, if the document mode is not the decoloring document mode (No in ACT 110), the CPU 80 displays the document mode screen 111 in which the character and photograph document button 112 is set by default (ACT 114).

The CPU 80 determines whether or not the decoloring document button 113 is selected (ACT 112). If the decoloring document button 113 is selected (Yes in ACT 112), the CPU 80 sets the decoloring document mode as the document mode (ACT 113), and returns to the processing in ACT 112. If the decoloring document button 113 is not selected (No in ACT 112), the CPU 80 determines whether or not the character and photograph document button 112 is selected (ACT 115). If the character and photograph document button 112 is selected (Yes in ACT 115), the CPU 80 sets the character and photograph document mode as the document mode (ACT 116), and returns to the processing in ACT 112. If the character and photograph document button 112 is not selected (No in ACT 115), the CPU 80 determines whether or not the return button is selected (ACT 117). If the return button is not selected (No in ACT 117), the CPU 80 returns to the processing in ACT 112. If the return button is selected (Yes in ACT 117), the CPU 80 returns to the processing in ACT 101 in FIG. 6.

In ACT 102 in FIG. 6, if the start key is pressed (Yes in ACT 102), the CPU 80 acquires the image data from the document by the scanner 84 (ACT 118). The CPU 80 determines whether or not the document mode is the decoloring document mode (ACT 119). If the document mode is the decoloring document mode (Yes in ACT 119), the CPU 80 sets the parameter for decoloring in the image processing section 85 (ACT 120), and executes the second image processing (ACT 121). The CPU 80 executes the image forming processing in response to the toner mode by the image forming section 86 (ACT 122), and terminates the present processing. The image data generated by the second image processing may be stored. In this way, the image data in which the color is emphasized can be left.

In ACT 119, if the document mode is not the decoloring document mode (No in ACT 119), the CPU 80 sets the parameter for black in the image processing section 85 (ACT 123), and executes the first image processing (ACT 124). The CPU 80 sets the decoloring document mode as the document mode, and sets the parameter for decoloring as the parameter for next image processing (ACT 125). The CPU 80 executes the image forming processing in response to the toner mode by the image forming section 86 (ACT 122), and terminates the present processing.

As shown in ACT 107 described above, in the present embodiment, the document mode for executing the second image processing of increasing the visibility of the color formed on the sheet regardless of the color material selected by the color material selection section 102 is set. In the color material selection section 102, if the decoloring toner is selected, by setting the decoloring document mode by default, the usability for the user is improved. The reasons are as follows.

If the document is the non-decoloring sheet, even if the image is formed by the second image processing in the decoloring document mode set by default, as the document of the formed sheet is only the image in which only the color is emphasized, it is not difficult for user to see the document.

On the other hand, in a case in which the document is the blue sheet, if the image is formed by the first image processing, the formed image becomes thin, and it takes time to copy again. Thus, if the decoloring document mode is set by default, even if the document is the decoloring sheet (e.g., a blue sheet) or the non-decoloring sheet, the user does not need to copy it again. Furthermore, if the image forming apparatus capable of forming the image with the decoloring toner is arranged to permit ready execution of the image formation by the decoloring toner, the decoloring sheet is often copied. Accordingly, by setting the decoloring document mode by default, the usability for the user can be improved.

The present disclosure is not limited to the above embodiments, and the decoloring document mode may be selected as default mode of the image processing even if non-decolorable toner such as black toner is selected in the color material selection section 102. It is suitable for saving clearer data for the decoloring document (e.g., the blue document) such as the decoloring toner in a copier having the function of saving scanned data of the document at the same time as copying.

According to the image forming apparatus of an embodiment as described above, it is possible to provide the image forming apparatus with the usability for the user improved.

The functions of the image forming apparatus according to the foregoing embodiments may be realized by a computer. In this case, programs for realizing the functions are recorded in a computer-readable recording medium and the programs recorded in the computer-readable recording medium may be read into a computer system to be executed. Further, it is assumed that the “computer system” described herein contains an OS or hardware such as peripheral devices. Further, the “computer-readable recording medium” refers to a portable medium such as a flexible disc, a magneto-optical disk, a ROM, a CD-ROM and the like or a storage device such as a hard disk built in the computer system. Furthermore, the “computer-readable recording medium” refers to a medium for dynamically holding the programs for a short time like a communication wire in a case in which the programs are sent via a communication line such as a network like the Internet or a telephone line. The “computer-readable recording medium” may hold the programs for a certain time like a volatile memory in the computer system serving as a server and a client. The foregoing programs may realize a part of the above-mentioned functions. Further, the foregoing program may be realized by the combination of the above-mentioned functions with the programs already recorded in the computer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus comprising:
a first image forming section configured to form a monochromatic image with a first color material;
a second image forming section configured to form a monochromatic image with a second color material different from the first color material;
a color material selection section configured to select either of the first color material or the second color material as a color material used in image formation by a user;
an acquisition section configured to read a document to acquire image data indicative of the document; and
a mode selection section configured to receive a selection, by a user, of either one of a first mode in which a first image processing is executed as an image processing on the image data acquired by the acquisition section or a second mode in which a second image processing, different from the first image processing, for increasing visibility of a color formed on a sheet regardless of the color material selected by the color material selection section is executed.

2. The image forming apparatus according to claim 1, wherein
the mode selection section displays a selection screen for a user to select either one of the first mode or the second mode, and
when the second color material as a color material used in an image formation is selected by the color material selection section, the mode selection section displays a selection screen in which the second mode is shown by default.

3. The image forming apparatus according to claim 1, wherein
in the first image processing and the second image processing, parameters relating to the image processing are different, and
a parameter relating to the second image processing is used to execute an image processing of emphasizing a color of the color material used in the image formation.

4. The image forming apparatus according to claim 2, wherein
in the first image processing and the second image processing, parameters relating to the image processing are different, and
a parameter relating to the second image processing is used to execute an image processing of emphasizing a color of the color material used in the image formation.

5. The image forming apparatus according to claim 1, further comprising:
an image processing section configured to execute both the first image processing and the second image processing.

6. The image forming apparatus according to claim 1, wherein
the second color material has lower color developing density than the first color material.

7. The image forming apparatus according to claim 5, wherein:
the image processing section is configured to execute, during the second image processing, edge emphasis processing to emphasize a change point of an image and a density difference between a ground and a character part.

8. The image forming apparatus according to claim 5, wherein:
the image processing section is configured to cause an image containing only color which has been emphasized to be formed on the sheet.

9. The image forming apparatus according to claim 1, wherein the mode selection section is configured to store the second image processing as a default mode.

10. An image forming method comprising:
controlling, by a controller, an image forming apparatus to form a monochromatic image with a first color material;
controlling the image forming apparatus to form a monochromatic image with a second color material different from the first color material;
setting either of the first color material or the second color material as a color material used in image formation in response to a selection of either of the first color material or the second color material by a user;
reading a document to acquire image data indicative of the document; and
receiving a selection, by the user, of either one of a first mode in which a first image processing is executed as an image processing on the acquired image data, or a second mode in which a second image processing, different from the first image processing, for increasing visibility of a color formed on a sheet regardless of the color material selected by the user.

11. The image forming method according to claim 10, further comprising:
displaying, at a display, a selection screen for a user to select either one of the first mode or the second mode,
wherein when the second color material as a color material used in an image formation is selected, the display shows the second mode as a default mode.

12. The image forming method according to claim 10, wherein
in the first image processing and the second image processing, parameters relating to the image processing are different, and
a parameter relating to the second image processing is used to execute image processing of emphasizing a color of the color material selected for the image formation.

13. The image forming method according to claim 11, wherein
in the first image processing and the second image processing, parameters relating to the image processing are different, and
a parameter relating to the second image processing is used to execute image processing of emphasizing a color of the color material selected for the image formation.

14. The image forming method according to claim 10, further comprising:
executing both the first image processing and the second image processing by a single image processing section.

15. The image forming method according to claim 10, wherein
the second color material has lower color developing density than the first color material.

16. The image forming method according to claim 10, further comprising:
executing, during the second image processing, edge emphasis processing to emphasize a change point of an image and a density difference between a ground and a character part.

17. The image forming method according to claim 10, wherein:
the controller is configured to cause an image containing only color which has been emphasized to be formed on the sheet.

18. The image forming method according to claim 10, wherein the second image processing comprises compensating for the lower density of the second color material.
